(19) United States
(12) Patent Application Publication
(10) Pub. No.: US 2026/0352629 A1
(43) Pub. Date: Nov. 5, 2026

(54) ZONE-BASED FIREWALL-ON-A-STICK

(71) Applicant: Cisco Technology, Inc., San Jose, CA (US)

(72) Inventors: Pritam Baruah, Fremont, CA (US); Saravanan Radhakrishnan, Bangalore (IN); Michael Tracy, Petaluma, CA (US)

(21) Appl. No.: 19/196,550

(22) Filed: May 1, 2025

(51) Int. Cl. H04L 9/40

(52) U.S. Cl. CPC H04L 63/0236; H04L 63/029; H04L 63/20

(57) ABSTRACT

In some embodiments, a method for a zone-based firewall-on-a-stick implementation includes receiving, at a router associated with a communication network, a data packet. The communication network may include one or more zones associated with respective security policies. The router may identify a source zone and a destination zone associated with the data packet. The source zone and the destination zone may form a zone pair associated with a security policy to be applied by a firewall. The router may attach metadata to the data packet. The metadata may include the source zone and the destination zone. The router may transmit the data packet along with the metadata to a firewall. The firewall may extract the source zone and the destination zone from the metadata and apply the security policy associated with at least one of the source zone and the destination zone.

### TECHNICAL FIELD

The present technology pertains to network security, and, more specifically, to zone-based firewalls.

### BACKGROUND

A Zone-Based Firewall (ZBF) is a security framework that regulates traffic based on the concept of zones and zone pairs. A zone represents logical groupings of VPNs or network interfaces with similar security requirements, while a zone pair defines the relationship between two zones to specify traffic enforcement policies. This approach enhances traffic segmentation and highly simplifies the management of firewall rules. The ZBF is often implemented as a dedicated firewall device/appliance placed at a strategic place in the network (such as a network edge) or configured inline with an SD-WAN router.

### BRIEF DESCRIPTION OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims.

FIG. 1 illustrates an example of a high-level network architecture according to some embodiments of the present technology.

FIG. 2 illustrates an example block diagram for a zone-based firewall-on-a-stick architecture according to some embodiments of the present technology.

FIG. 3 illustrates an example block diagram for identifying the zones for the zone-based firewall-on-a-stick architecture according to some embodiments of the present technology.

FIG. 4 illustrates an example flowchart for the zone-based firewall-on-a-stick architecture according to some embodiments of the present technology.

FIG. 5 illustrates an example network device 500 suitable for performing switching, routing, load balancing, and other networking operations, according to some embodiments of the present technology.

FIG. 6 shows an example of a system for implementing certain embodiments of the present technology according to some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Embodiments of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

In some embodiments, a method for a zone-based firewall-on-a-stick implementation includes receiving, at a router associated with a communication network, a data packet. The communication network may include one or more zones associated with respective security policies. The router may identify a source zone and a destination zone associated with the data packet. The source zone and the destination zone may form a zone pair associated with a security policy to be applied by a firewall. The router may attach metadata to the data packet. The metadata may include the source zone and the destination zone. The router may transmit the data packet along with the metadata to a firewall. The firewall may extract the source zone and the destination zone from the metadata and apply the security policy associated with at least one of the source zone and the destination zone.

In some embodiments, the firewall determines that the modified data packet is permitted based on the security policy. The router may receive, from the firewall, the modified data packet, and forward the modified data packet to a destination router associated with the destination zone.

In some embodiments, the firewall determines that the modified data packet is not permitted based on the security policy.

In some embodiments, the source zone and the destination zone are identified using an identification method that is a VPN, an interface, a data policy, or an interface-ACL.

In some embodiments, the router may receive, from the firewall, the modified data packet, and forwarding the modified data packet to a source router associated with the source zone.

In some embodiments, the firewall terminates the data packet.

In some embodiments, the source zone and the destination zone are identified using a hierarchical method of zone identification that includes at least a first identification method and a second identification method that are associated with a respective precedence. Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A Zone-Based Firewall (ZBF) is a security framework that regulates traffic based on the concept of zones and zone pairs. A zone represents logical groupings of VPNs or network interfaces with similar security requirements, while a zone pair defines the relationship between two zones to specify traffic enforcement policies. This approach enhances traffic segmentation and highly simplifies the management of firewall rules. The ZBF is often implemented as a dedicated firewall device/appliance placed at a strategic place in the network (such as a network edge) or configured inline with an SD-WAN router. The inline ZBF model has some disadvantages, including a low throughput, not-best-in-class enforcement capability, and clustering and state sync capability is usually not present or requires complex configuration. One solution to the issue with the inline ZBF model is the “firewall-on-a-stick” architecture. However, a major disadvantage of a Firewall-on-a-Stick is that it cannot do zone-based firewalling (until the present technology), as it cannot identify the zone pair (lack of routing table and interfaces to an edge device do not preserve network semantics). This implies that enforcement needs to be based on ACL type rules, hence greatly increasing the complexity and number of policy sequences. Another disadvantage is that firewalls are unable to identify zones based on complex routing parameters such as source-destination networks or security groups or in general, when forwarding is performed by Policy-Based Routing (PBR).

Disclosed herein is a method for integrating ZBF and a firewall-on-a-stick architecture. The firewall-on-a-stick architecture includes an “inserted” firewall that is associated with a router. Traffic associated with the network (e.g., from the router, or additional routers and/or other devices associated with the network) may be automatically redirected to the router for rule enforcement. The router may analyze the traffic (e.g., data packet) and may determine a source zone, a route, and a destination zone.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

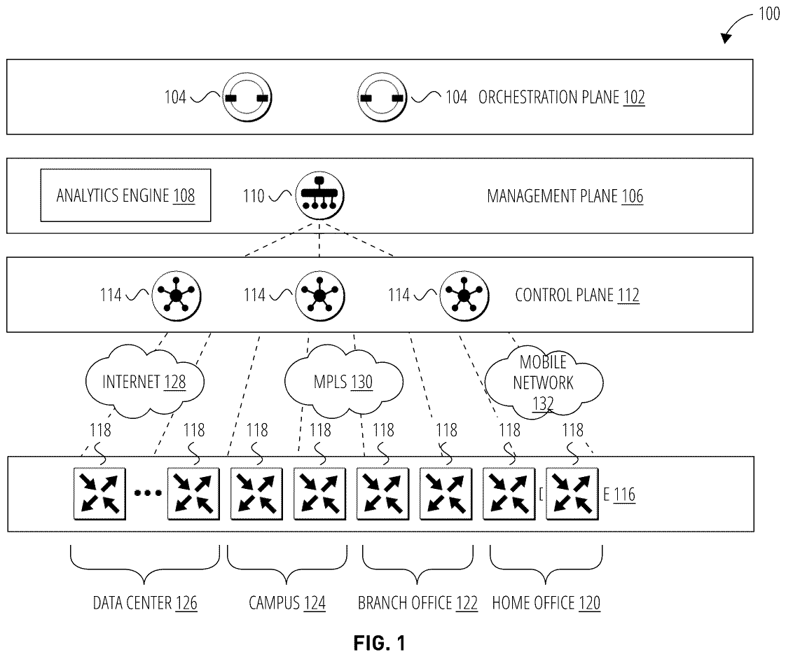

FIG. 1 illustrates an example of a network architecture 100 for implementing embodiments of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110 and an analytics engine 108. The analytics engine 108 may monitor network performance, analyze traffic patterns, and provide insights to optimize routing, security, and application performance across the network. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

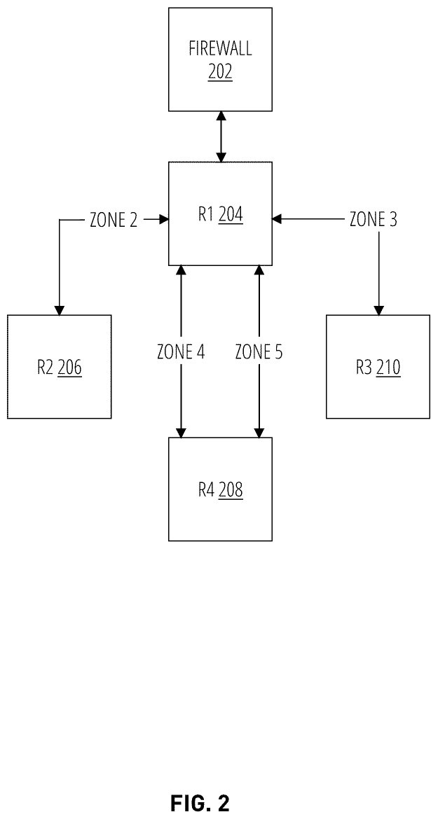

FIG. 2 illustrates an example block diagram for a zone-based firewall-on-a-stick architecture according to some embodiments of the present disclosure. The zone-based firewall-on-a-stick may be implemented on a SD-WAN network, such as a network described in FIG. 1. In some other examples, zone-based firewall-on-a-stick may be implemented in another type of network, such as a local area network (LAN), a wide area network (WAN), wireless LAN (e.g., WiFi), any combination thereof, or the like. The network may include a series of routers. For example, the network may include R1 204, R2 206, R3 210, and R4 208. The routers may be associated with respective routes, edge devices, client devices, services, cloud-based resources, any combination thereof, or the like. Transmissions may be directed throughout the network via the series of routers.

In some examples, a network administrator (e.g., via a controller associated with the network) may identify one or more zones within the network. The zones may be divided according to location, security protocol, department (e.g., human resources, engineering, sales, etc.), building, resource requirements, credential, any combination thereof, or the like. In some examples, the zones may be identified as “trusted,” “untrusted,” demilitarized zone (DMZ) for shared services, Internet-of-Things (IoT) devices, “guest,” etc. For the zones, security requirements may differ from zone to zone. For example, a human resources “zone” may be permitted to access certain locations that the engineering “zone” does not have permission to access (e.g., personnel files). R2 206, R3 210, and R4 208 may function as edge routers for a segment (e.g., “zone”) of the network. As shown in FIG. 2, R2 206 may receive traffic coming to and/or from zone 2, R3 210 may receive traffic coming to and/or from zone 3, and R4 208 may receive traffic coming to and/or from zone 4 and zone 5. Security requirements may be applied based on a zone pair. A zone pair may include a source zone and a destination zone. According to the zone pair, a certain security protocol is implemented at a firewall. In some examples, the security protocols are implemented using a firewall-on-a-stick architecture.

Firewall-on-a-stick is a network security architecture where a single firewall interfaces with multiple routers and/or zones of the network using a single physical connection, typically through a trunk link with a designated router. This configuration relies on inter-network routing, where tagged traffic is passed between the firewall and a router, allowing the firewall to inspect and enforce security policies across multiple network segments without requiring multiple physical interfaces. Firewall-on-a-stick is commonly implemented in environments where cost, physical space, or hardware limitations necessitate a streamlined security solution while still maintaining segmentation and policy enforcement. The efficiency of this approach depends on the firewall's processing capabilities and the router's ability to handle network tagging and traffic forwarding effectively. For example, firewall 202 may be connected to the network via R1 204. Traffic on the network, such as traffic from R2 206 to R4 208, may be redirected to R1 204 (and subsequently firewall 202) for processing. Firewall 202 may apply any security protocols to the traffic before forwarding the traffic to a destination. However, in some examples, firewall-on-a-stick cannot identify a zone pair associated with traffic on a network (e.g., lack of routing table and interfaces). Enforcing zones can be implemented based on access control list (ACL)-type rules, but this may greatly increase the complexity and number of policy sequences. Further, a firewall-on-a-stick may be unable to identify zones based on complex routing parameters, such as source-destination networks or security groups. Additionally, firewall-on-a-stick may be unable to identify zones when forwarding is performed by policy-based routing (PBR).

The present disclosure describes an implementation that includes firewall 202 connected to R1 204, wherein R1 204 performs the zone identification procedure on a data packet prior to forwarding the data packet to firewall 202. For example, a data packet may be transmitted from a first device associated with zone 4. The data packet may include a source identifier and a destination identifier. The data packet may be routed to R1 204 automatically. The automatic routing may be performed according to configurations associated with the network, such as a configuration implemented after an installation of firewall 202.

R1 204 may identify the source identifier and the destination identifier (e.g., an Internet Protocol (IP) address, a MAC address, a port number, or any other identifier that may be used to identify a source device and/or a destination device on a network) from the data packet. Using a routing table, R1 204 may identify a source zone associated with the source identifier. The routing table may be stored locally, may be accessible by R1 204 at a database associated with the network, may be stored at a cloud-based database accessible by R1 204, any combination thereof, or the like. R1 204 may, using the source identifier and the destination identifier, determine a route for the data packet (e.g., a route through the network from the device associated with the source identifier to the device associated with the destination identifier). R1 204 may utilize the determined route to identify a destination zone associated with the destination identifier.

R1 204 may transmit the data packet to firewall 202. In some examples, R1 204 may include metadata associated with the source zone and the destination zone in the data packet for reference by firewall 202. Firewall 202 may extract the source zone and the destination zone and may identify at least one applicable security policy. The applicable security policy may be specific to the zone pair (e.g., the combination of the source zone and the destination zone), a zone (e.g., a policy specific to all traffic to the destination zone, a policy specific to all traffic from the source zone), the combination of the traffic flow and the zones (e.g., specifically applies to traffic from the source zone to the destination zone), any combination thereof, or the like. Firewall 202 may apply the applicable security policy to the data packet and may forward the data packet (with the security policy applied) to R1 204, if the data packet is permitted. In some examples, firewall 202 may apply more than one applicable security policy to the data packet. The data packet (based on the applicable security policy) may not be permitted and firewall 202 may instruct R1 204 to terminate the data packet, forward the data packet back to the device associated with the source identifier, alert an administrative device of the network, modify the destination of the data packet, any combination thereof, or the like.

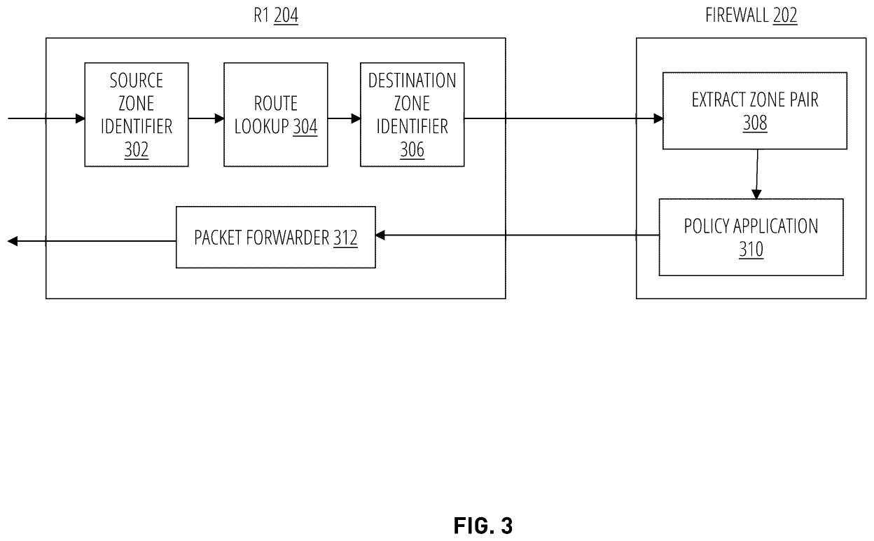

FIG. 3 illustrates an example block diagram for identifying the zones for the zone-based firewall-on-a-stick architecture according to some embodiments of the present disclosure. R1 204 and firewall 202 may be components of a communication network configured with one or more zones. R1 204 may be configured to identify associated zones (e.g., source zone and destination zone) of a data packet transmitted through the communication network. Firewall 202 may be configured to apply associated security policies to the data packet based on the identified zones provided by R1 204.

To identify the zones of a data packet, R1 204 may include one or more components, including, but not limited to, source zone identifier 302, route lookup 304, destination zone identifier 306, and packet forwarder 312. These components may operate alone or in combination to identify at least a source zone and a destination zone associated with a data packet and forwarding a transformed data packet to firewall 202 for processing. For example, a data packet may be transmitted to R1 204 using a service insertion policy. The service insertion policy may utilize policy-based routing, traffic redirection, or service chaining to direct specific traffic flows on the communication network through designated network functions (e.g., firewall 202). The service insertion policy may be implemented using overlay routing, SD-WAN policies, network function visualization, any combination thereof, or the like. The service insertion policy ensures that traffic from the communication network follows the required security and performance paths without altering the underlying network topology.

Source zone identifier 302 may receive the data packet. The data packet may include at least a source identifier, a destination identifier, and content. Source zone identifier 302 may be configured to identify a source zone based on the source identifier. In some examples, the source identifier is associated with an ingress interface and/or an ingress Virtual Private Network (VPN). For example, an ingress interface may be identified by a physical and/or logical interface identifier and may be mapped to the source zone. In another example, an ingress VPN may be determined by tunnel encapsulation (e.g., GRE, IPsec, MPLS, etc.) and be associated with an SD-WAN overlay, which may be associated with the source zone. In some examples, an action may be defined (e.g., based on interface ACL, or a data policy) by an administrative device associated with the network. Interface ACL and/or data policy, based on the action, may provide a source zone based on the source identifier (e.g., an IP address, a port, a protocol, VPN labels, Differentiated Services Code Point (DSCP) markings, application signatures, any combination thereof, or the like, that may be identified in the data packet).

In some examples, source zone identifier 302 may be associated with a hierarchical approach to identifying the source zone from the source identifier. The hierarchical approach may include an order of preference associated with one or more methods for determining the source zone based on the source identifier. The order of preference may be determined by a policy from the administrative device associated with the communication network. For example, source zone identifier 302 may attempt to identify the source zone by ingress VPN. If that method is unsuccessful, source zone identifier 302 may attempt to identify the source zone by ingress interface. If the router is unable to identify the source zone by the ingress VPN and the ingress interface, source zone identifier 302 of R1 204 may attempt to identify the source zone using interface ACL actions. If interface ACL actions are also unsuccessful, then source zone identifier 302 may also attempt to identify the source zone using a data policy action. Source zone identifier 302 may identify the source zone using the hierarchical approach. Source zone identifier 302 may transmit the data packet to route lookup 304.

Route lookup 304 may be configured to identify a route associated with the source identifier (and/or the source zone identified by source zone identifier 302) and the destination identifier. The route may include a next hop for the data packet. In some examples, route lookup 304 may identify a complete route from a device associated with the source identifier. Destination zone identifier 306 may be configured to identify the destination zone associated with the data packet using the destination identifier and the route identified by route lookup 304. In some examples, destination zone identifier 306 may use a same or similar hierarchical approach as source zone identifier 302 (e.g., including an order of preference). For example, destination zone identifier 306 may attempt to identify the destination zone by egress VPN. If that method is unsuccessful, destination zone identifier 306 may attempt to identify the destination zone by egress interface. If the destination zone identifier 306 of R1 204 is unable to identify the destination zone by the egress VPN and the egress, destination zone identifier 306 may attempt to identify the destination zone using interface ACL actions. If interface ACL actions are also unsuccessful, then destination zone identifier 306 may also attempt to identify the destination zone using a data policy action. Destination zone identifier 306 may identify the destination zone using the hierarchical approach.

The destination zone (identified by destination zone identifier 306) and the source zone (identified by source zone identifier 302) may be inserted as a zone pair as metadata (e.g., using encapsulation, such as VXLAN, MPLS, IPSec, GRE, etc.) in the data packet before the data packet is forwarded to firewall 202. For example, destination zone identifier 306 may receive the source zone from source zone identifier 302 and may include the zone pair as metadata as a final processing step prior to transmitting the data packet to firewall 202. In some examples, the metadata follows the MDATA format and may be encapsulated to a tunnel and/or to raw IP or ethernet packets. In some examples, an application may be identified (e.g., at source zone identifier 302 and/or destination zone identifier 306) and associated with the data packet. The application may also be included in the metadata. The tagged data packet (e.g., including the zone pair) may be forwarded to firewall 202.

Firewall 202 may include one or more components that are configured to identify and execute security policies associated with the communication network and one or more zones of the communication network. Firewall 202 may, in some examples, enforce security policies by forwarding the data packet to a destination (e.g., an egress interface, a destination device, any combination thereof, or the like), dropping the data packet (e.g., silently discarding or rejecting with an error message), logging the data packet (e.g., recording the data packet for security auditing), and/or modifying the data packet (e.g., NAT, QoS tagging, and/or service redirection). To identify applicable security policies, extract zone pair 308 may identify the source zone and the destination zone from the tagged data packet received from R1 204. The policy database may be stored in memory accessible by firewall 202, such as local memory, at a controller (e.g., SD-WAN controller) associated with the communication network, at a centralized management system, at a cloud-based storage location accessible by firewall 202, any combination thereof, or the like. The policy database may include rules associated with zones and/or zone pairs. For example, a source zone and a destination zone combination may receive a specific type of treatment by firewall 202. Firewall 202 may query the policy database for a policy applicable to the zone pair.

Based on the applicable policy, firewall 202 may identify a treatment for the tagged data packet (e.g., forwarding, dropping, logging, and/or modifying) at policy application 310. If firewall 202 determines that the tagged data packet is permitted and complies with an applicable security policy, firewall 202 forwards the tagged data packet to packet forwarder 312. In some examples, the tagged data packet still includes the metadata associated with the zone pair and/or the application. The metadata may be stored by R1 204 for data analytics. Packet forwarder 312 may forward the tagged data packet to the destination associated with the destination identifier within the destination zone.

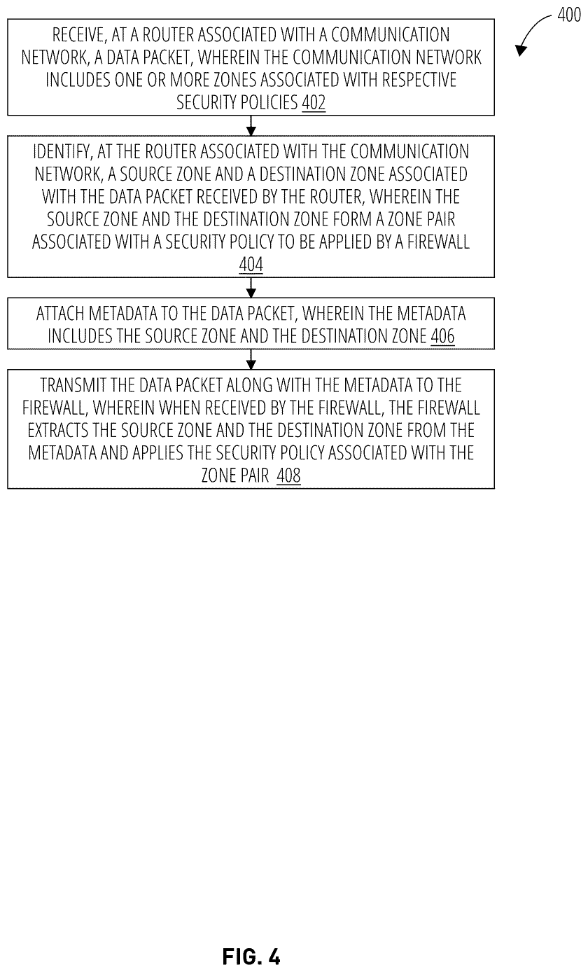

FIG. 4 illustrates an example flowchart for the zone-based firewall-on-a-stick architecture according to some embodiments of the present disclosure.

In block 402, routine 400 receives, at a router associated with a communication network, a data packet, wherein the communication network includes one or more zones associated with respective security policies. For example, R1 204 (as described in FIG. 2 and FIG. 3) may be associated with a communication network and may receive a data packet, where the communication network includes one or more zones associated with respective security policies. The data packet may include a source identifier and a destination identifier. The data packet may be routed to the router automatically due to a service insertion policy.

In block 404, routine 400 identifies a source zone and a destination zone associated with the data packet, wherein the one or more zones includes the source zone and the destination zone. For example, R1 204 may identify a source zone and a destination zone associated with the data packet, where the one or more zones includes the source zone and the destination zone. In some examples, the source zone is identified using an ingress interface and/or an ingress VPN. In some examples, the source zone is identified using an action associated with interface ACL and/or data policy. R1 204 may implement a hierarchical approach to identifying the source zone from the source identifier, which may include an order of preference associated with one or more methods for determining the source zone based on the source identifier (e.g., ingress interface, ingress VPN, interface ACL, data policy, etc.). The destination zone may be identified by R1 204 using the same or similar method to the source zone identification (e.g., egress interface, egress VPN, interface ACL, data policy, etc.) and using a similar hierarchical approach.

In block 406, routine 400 modifies the data packet to generate a modified data packet that includes the source zone and the destination zone as metadata attached to the modified data packet. For example, R1 204 may modify the data packet to generate a modified data packet that includes the source zone and the destination zone as metadata attached to the modified data packet. The destination zone and the source zone may be inserted as a zone pair as metadata (e.g., using encapsulation, such as VXLAN, MPLS, IPSec, GRE, etc.). In some examples, an application associated with the data packet may also be included as metadata in the data packet.

In block 408, routine 400 transmits the modified data packet to a firewall, wherein when received by the firewall, the firewall extracts the source zone and the destination zone from the modified data packet and applies a security policy associated with at least one of the source zone and the destination zone. For example, R1 204 may transmit the modified data packet to firewall 202 (as described in FIG. 2), where when received by firewall 202, firewall 202 extracts the source zone and the destination zone from the modified data packet and applies a security policy associated with at least one of the source zone and the destination zone. The firewall may query a policy database for a policy associated with at least one of the source zone and the destination zone. The firewall may enforce the policy by forwarding the data packet to a destination (e.g., an egress interface, a destination device, any combination thereof, or the like), dropping the data packet (e.g., silently discarding or rejecting with an error message), logging the data packet (e.g., recording the data packet for security auditing), and/or modifying the data packet (e.g., NAT, QoS tagging, and/or service redirection).

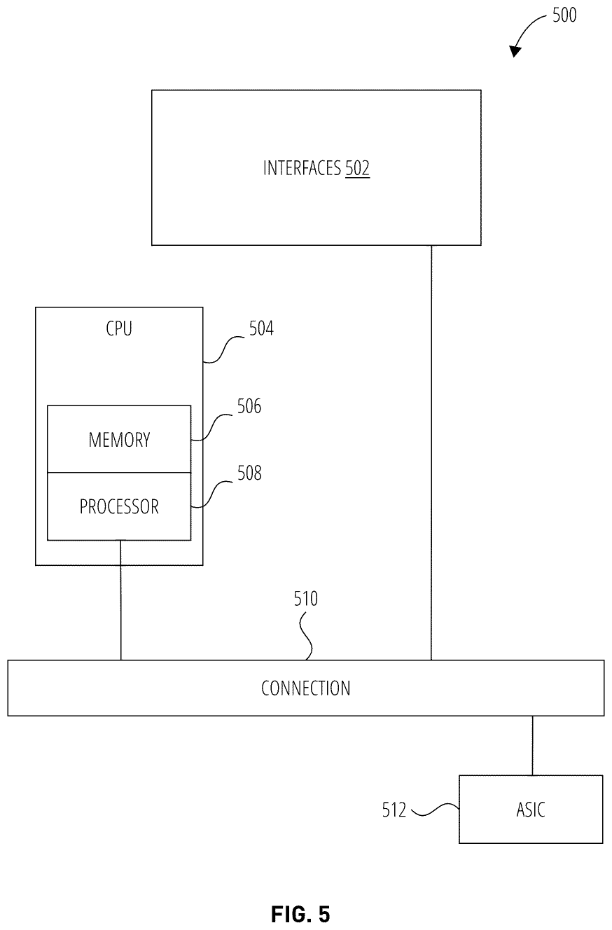

FIG. 5 illustrates an example network device 500 suitable for performing switching, routing, load balancing, and other networking operations, according to some embodiments of the present disclosure. The example network device 500 can be implemented as switches, routers, nodes, metadata servers, load balancers, client devices, and so forth.

Network device 500 includes a central processing unit (CPU) 504, interfaces 502, and a bus 510 (e.g., a PCI bus). When acting under the control of appropriate software or firmware, the CPU 504 is responsible for executing packet management, error detection, and/or routing functions. The CPU 504 preferably accomplishes all these functions under the control of software including an operating system and any appropriate applications software. CPU 504 may include one or more processors 508, such as a processor from the INTEL X86 family of microprocessors. In some cases, processor 508 can be specially designed hardware for controlling the operations of network device 500. In some cases, a memory 506 (e.g., non-volatile RAM, ROM, etc.) also forms part of CPU 504. However, there are many different ways in which memory could be coupled to the system.

The interfaces 502 are typically provided as modular interface cards (sometimes referred to as “line cards”). Generally, they control the sending and receiving of data packets over the network and sometimes support other peripherals used with the network device 500. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 504) to efficiently perform routing computations, network diagnostics, security functions, etc.

Although the system shown in FIG. 5 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 500.

Regardless of the network device's configuration, it may employ one or more memories or memory modules (including memory 506) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 506 could also hold various software containers and virtualized execution environments and data.

The network device 500 can also include an application-specific integrated circuit (ASIC) 512, which can be configured to perform routing and/or switching operations. The ASIC 512 can communicate with other components in the network device 500 via the bus 510, to exchange data and signals and coordinate various types of operations by the network device 500, such as routing, switching, and/or data storage operations, for example.

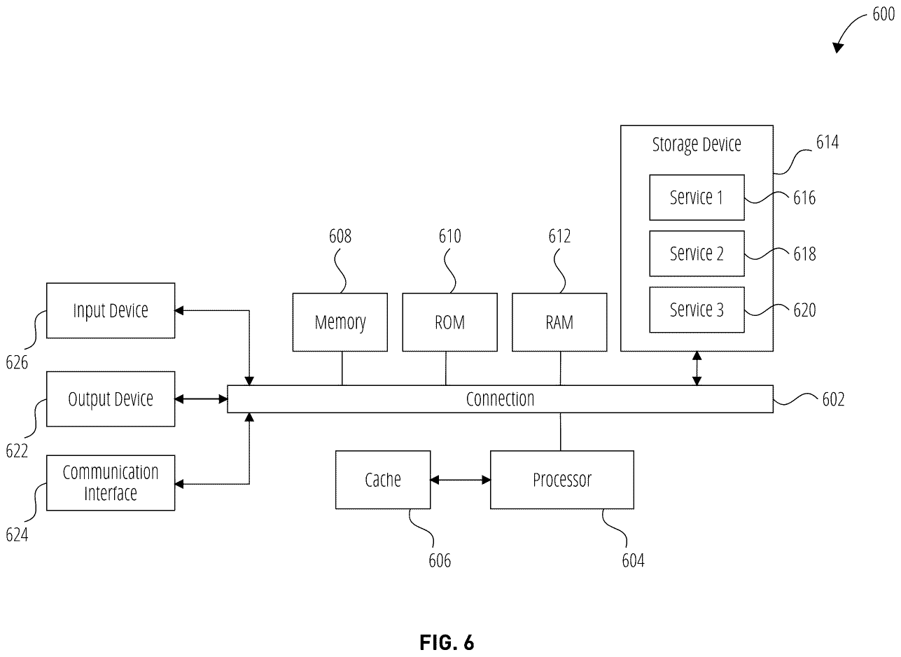

FIG. 6 shows an example of computing system 600, which can be for example any computing device making up R1 204, firewall 202, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
receiving, at a router associated with a communication network, a data packet, wherein the communication network includes one or more zones associated with respective security policies;
identifying, at the router associated with the communication network, a source zone and a destination zone associated with the data packet received by the router, wherein the source zone and the destination zone form a zone pair associated with a security policy to be applied by a firewall;
attaching metadata to the data packet, wherein the metadata includes the source zone and the destination zone; and
transmitting the data packet along with the metadata to the firewall, wherein when received by the firewall, the firewall extracts the source zone and the destination zone from the metadata and applies the security policy associated with the zone pair.

2. The computer-implemented method of claim 1, wherein the firewall interfaces with the router using a single connection in a firewall-on-a-stick configuration.

3. The computer-implemented method of claim 1, further comprising:
after the firewall determines that the data packet complies with the security policy, receiving, by the router, the data packet; and
forwarding the data packet to a destination associated with the destination zone.

4. The computer-implemented method of claim 1, wherein the firewall determines that the data packet does not comply with the security policy.

5. The computer-implemented method of claim 4, further comprising:
receiving, from the firewall, the data packet; and
forwarding the data packet to a source associated with the source zone.

6. The computer-implemented method of claim 4, wherein the firewall terminates the data packet.

7. The computer-implemented method of claim 1, wherein the source zone and the destination zone are identified using an identification method that is a virtual private network (VPN), an interface, a data policy, or an interface access control list (ACL).

8. The computer-implemented method of claim 7, wherein the source zone and the destination zone are identified using a hierarchical method of zone identification that includes at least a first identification method and a second identification method that are associated with a respective precedence.

9. The computer-implemented method of claim 1, wherein the metadata includes application data associated with the data packet.

10. The computer-implemented method of claim 1, further comprising:
receiving, from the firewall, the data packet, wherein the data packet includes the metadata.

11. A system for implementing zone-based security policies, comprising:
a communication network, wherein the communication network includes one or more zones associated with respective security policies;
a router configured to receive a data packet from within the communication network and identify a source zone and a destination zone associated with the data packet, wherein the source zone and the destination zone form a zone pair associated with a security policy, and wherein the router attaches metadata to the data packet that includes the source zone and the destination zone; and
a firewall configured to receive the data packet from the router and extract the source zone and destination zone from the metadata attached to the data packet, wherein the firewall applies the security policy associated with the zone pair, and wherein the firewall is in a firewall-on-a-stick configuration.

12. The system of claim 11, wherein the firewall interfaces with the router using a single connection in the firewall-on-a-stick configuration.

13. The system of claim 11, wherein after the firewall determines that the data packet complies with the security policy, the router forwards the data packet to a destination associated with the destination zone.

14. The system of claim 11, wherein the firewall determines that the data packet does not comply with the security policy.

15. The system of claim 14, wherein after the firewall determines that the data packet does not comply with the security policy, the router forwards the data packet to a source associated with the source zone.

16. The system of claim 14, wherein the firewall terminates the data packet.

17. The system of claim 11, wherein the source zone and the destination zone are identified using an identification method that is a virtual private network (VPN), an interface, a data policy, or an interface access control list (ACL).

18. The system of claim 17, wherein the source zone and the destination zone are identified using a hierarchical method of zone identification that includes at least a first identification method and a second identification method that are associated with a respective precedence.

19. The system of claim 11, wherein the metadata includes application data associated with the data packet.

20. A non-transitory computer-readable storage medium comprising instructions that, when executed by a computer, cause the computer to:
receive, at a router associated with a communication network, a data packet, wherein the communication network includes one or more zones associated with respective security policies;
identify, at a router associated with the communication network, a source zone and a destination zone associated with the data packet received by the router, wherein the source zone and the destination zone form a zone pair associated with a security policy to be applied by a firewall;
attach metadata to the data packet, wherein the metadata includes the source zone and the destination zone; and
transmit the data packet along with the metadata to the firewall, wherein when received by the firewall, the firewall extracts the source zone and the destination zone from the metadata and applies the security policy associated with the zone pair.
